(19) United States
(12) Patent Application Publication
(10) Pub. No.: US 2018/0288226 A1
(43) Pub. Date: Oct. 4, 2018

(54) HIGH PERFORMANCE DISTRIBUTED COMPUTER WORK ASSIGNMENT ENGINE

(71) Applicant: Avaya Inc., Santa Clara, CA (US)

(72) Inventors: Jerry J. Collins, Galway (IE); James S. Collins, Galway (IE)

(21) Appl. No.: 15/477,672

(22) Filed: Apr. 3, 2017

(51) Int. Cl. H04M 3/523; H04M 3/51

(52) U.S. Cl. CPC H04M 3/5232; H04M 3/5183

(57) ABSTRACT

A work item (e.g., a voice call) is received by a resource mapper. A request to match the work item is sent to a plurality of resource nodes (e.g., a plurality of different servers) that each manage one or more separate resources (e.g., a plurality of contact center agents). Each resource node determines a best available resource among their respective one or more separate resources. Each resource node sends a bid for the best available resource to a resource selector. The resource selector selects a best resource from among the bids. Each resource node receives an accept or a reject message for the sent bid. Based on the winning bid, the work item is then routed to the resource for processing. This allows for separate processing resources (e.g., distributed in a network) to manage the processing tasks associated with determining the best resource to match to a work item.

### BACKGROUND

Work assignment engines are computer systems that match a work item (e.g., an incoming voice or video communication session) to a resource (e.g., a communication device of a contact center agent). Current work assignment engines cannot support processing work items concurrently and at the same time guarantee that the best resources are matched to the best work items.

One solution to solve this problem was to develop a monolithic work assignment engine (e.g., a single server/single process implementation). However, a monolithic work assignment engines have limitations. For example, because the monolithic work assignment is limited to a single server, the monolithic work assignment engine cannot scale where a large number of work items need to be processed (e.g., in a large contact center). The monolithic work assignment engine just does not have the necessary computer processing performance to scale to the needs of today's systems.

### SUMMARY

These and other needs are addressed by the various embodiments and configurations of the present disclosure. A work item (e.g., a voice call) is received by a resource mapper. A request to match the work item is sent to a plurality of resource nodes (e.g., a plurality of different servers) that each manage one or more separate resources (e.g., a plurality of contact center agents). Each resource node determines a best available resource among their respective one or more separate resources (or zero available resources). Each resource node sends a bid for the best available resource to a resource selector. The resource selector selects a best resource from among the bids. Each resource node receives an accept or a reject message for the sent bid. Based on the winning bid, the work item is then routed to the resource for processing. This allows for separate processing resources (e.g., distributed in a network) to manage the processing tasks associated with determining the best resource to match to a work item.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system of a distributed work assignment system.

FIG. 2 is a block diagram of a second illustrative system of a distributed work assignment system.

FIG. 3 is a flow diagram of a process for distribution of work items in a distributed work assignment system.

FIG. 4 is a flow diagram of a process for distribution of work items in a distributed work assignment system.

FIG. 5 is a flow diagram of a process for selecting a resource to service a work item in a work assignment system.

### DETAILED DESCRIPTION

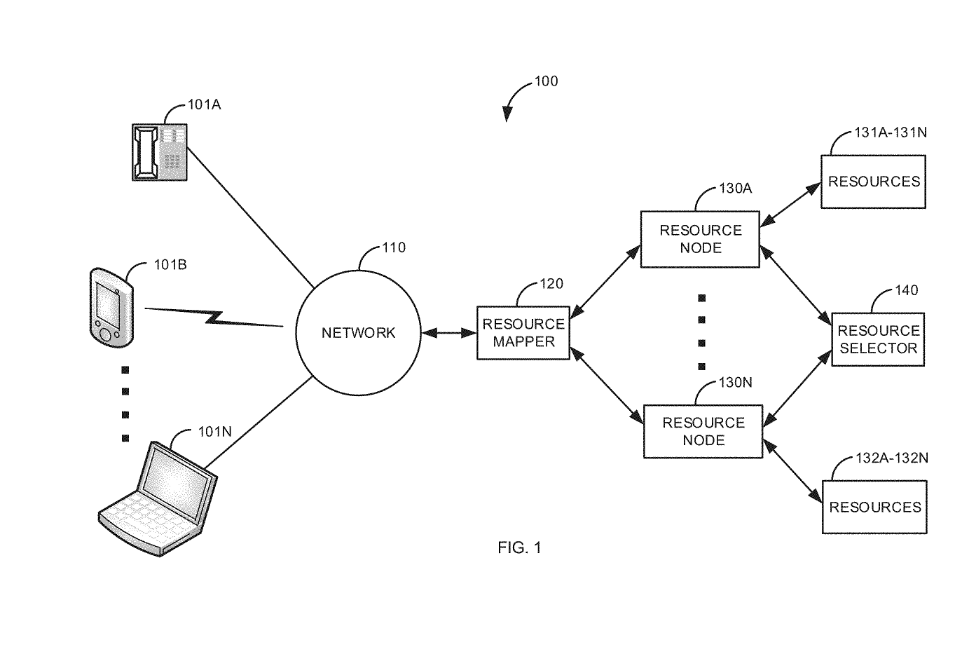

FIG. 1 is a block diagram of a first illustrative system 100 of a distributed work assignment system. The first illustrative system 100 comprises communication endpoints 101A-101N, a network 110, a resource mapper 120, resource nodes 130A-130N, resources 131A-131N, resources 132A-132N, and a resource selector 140.

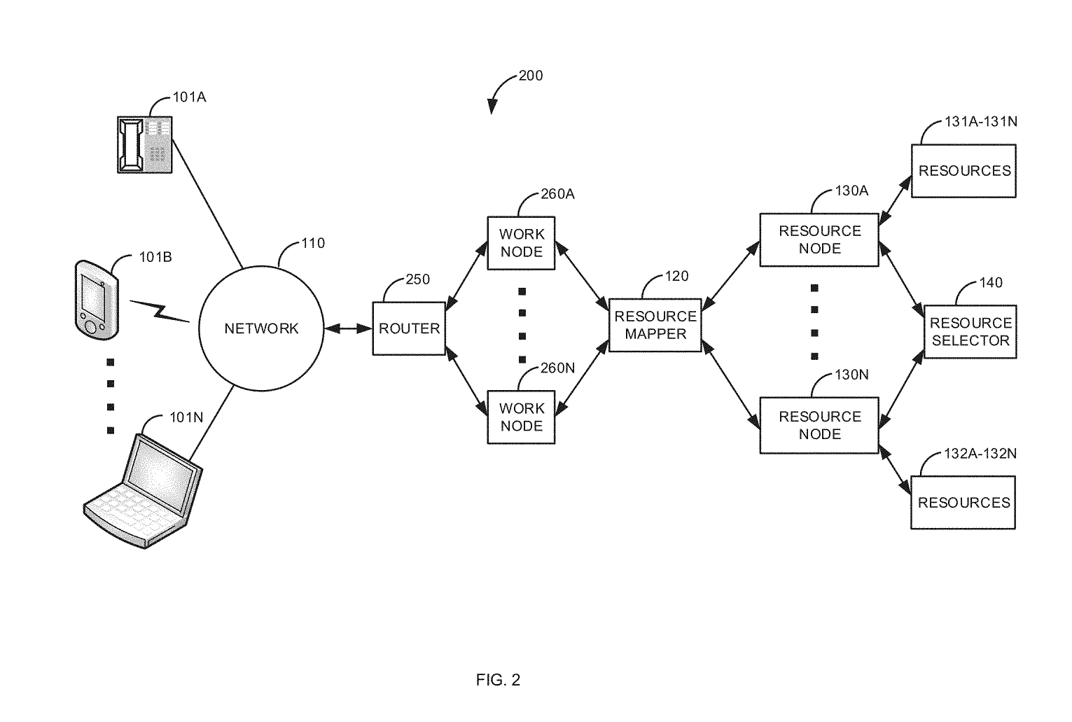

The communication endpoints 101A-101N can be or may include any communication endpoint device that can communicate on the network 110, such as a Personal Computer (PC), a telephone, a video camera, a cellular telephone, a Personal Digital Assistant (PDA), a tablet device, a notebook device, a smart phone, and/or the like. As shown in FIG. 1, any number of communication endpoints 101A-101N may be connected to the network 110, including only a single communication endpoint 101 A user of a communication endpoint 101 may initiate a communication (i.e., a work item) that is directed toward the resource mapper 120 or the router 250 of FIG. 2.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), Integrated Services Digital Network (ISDN), video protocols, instant messaging protocols, text messaging protocols, email protocols, and/or the like. Thus, the network 110 is an electronic communication network configured to carry messages via packets and/or circuit switched communications.

In FIG. 1, the network 110 is shown as a single network. However, in other embodiments, the network 110 may comprise multiple networks. For example, the communication endpoints 101A-101N may be on the PSTN or Internet and the resource mapper 120, the resource nodes 130A-130N, the resources 131A-131N and 132A-132N, and the resource selector 140 may be on a separate corporate network 110 in a contact center. Alternatively, the resource mapper 120, the resource nodes 130A-130N, the resources 131A-131N and 132A-132N, and the resource selector 140 may be on a separate corporate network 110 that is part of a system for booking flights, ordering parts, booking seats, and/or the like

The resource mapper 120 can be or may include any hardware coupled with software that can route work items, such as a Private Branch Exchange, (PBX), a switch, a router, a proxy server, and/or the like. A work item is typically a type of communication, such as a voice call, a video call, an instant message session, an email, a text message, a data message (e.g., a Java Script Object Notation (JSON)/Extended Markup Language (XML) message), and/or the like. However, in other embodiments, the work item may be a trouble ticket, a work order, a processing request, a manufacturing request, and/or the like. The resource mapper 120 may be programmed to manage different types of work items. For example, the resource mapper 120 may be able to manage voice calls and trouble tickets simultaneously.

The resource mapper 120 is programmed to send a request to match work items to a group of resource nodes 130A-130N. The resource mapper 120 may send a request for a received work item to each of the resource nodes 130A-130N. In an alternative embodiment, depending on the type of work item, the resource mapper 120 may send work items to different groups of resource nodes 130. For example, the resource mapper 120 may send voice calls to resource nodes 130A-130C and instant message calls to resource nodes 130D-130N.

The resource nodes 130A-130N can be or may include any hardware coupled with software that can manage resources 131. A resource 131/132 may be a human resource or a computer resource. For example, a resource 131/132 may be a contact center agent, a technical support agent, a support technician, an Interactive Voice Response (IVR) system, a computer resource, a communication device, a server, a media player, a recorder, a voicemail system, a web/Representational State Transfer (REST) service, and/or the like. As shown in FIG. 1, resource node 130A manages resources 131A-131N and resource node 130N manages resources 132A-132N. In FIG. 1, the resource nodes 130A-130N/132A-132N may comprise any number of resource nodes 130 and their associated collection of resources 131A-131N/132A-132N.

The resource selector 140 can be or may include any hardware coupled with software that can manage the selection of resources 131/132 that are submitted in bids from the resource nodes 130A-130N. The resource selector 140 can use different computer algorithms in selecting bids based on the type of work items being managed. However, the algorithm used by the resource selector 140 should be a similar algorithm to the algorithm used on the resources nodes 130A-130N for a given work item.

In FIG. 1, the resource mapper 120, the individual resource nodes 130A-130N, and the resource selector 140 may be on executed on separate servers on the network 110, executing as separate computer threads, executing on separate computer cores, and/or the like. For example, the resource mapper 120 may be executing on a first server on the network 110, the resource nodes 130A-130N may be executing on separate computer cores on a second server on the network 110, and the resource selector 140 may be executing on a thread on a third server on the network 110.

FIG. 2 is a block diagram of a second illustrative system 200 of a distributed work assignment system. The second illustrative system 200 comprises the communication endpoints 101A-101N, the network 110, a router 250, work nodes 260A-260N, the resource mapper 120, the resource nodes 130A-130N, the resources 131A-131N, the resources 132A-132N, and the resource selector 140.

The router 250 can be or may include any hardware coupled with software that can route work items (e.g., voice or video calls, instant messaging, text messages, emails, data messages (e.g., JSON, XML, etc. from the communication endpoints 101A-101N), such as a Private Branch Exchange (PBX), a proxy server, a network switch, a session manager, a communication manager, and/or the like. The router 250 routes the work items to the work nodes 260A-260N.

The work nodes 260A-260N can be or may include any hardware coupled with software that can hold work items. The work nodes 260A-260N may hold work items in various ways, such as in a pool of work items, in a queue (e.g., a contact center queue), and/or the like. The work nodes 260A-260N may hold work items, such as incoming voice calls, incoming video calls, incoming Instant Messaging sessions, incoming emails, incoming text messages, incoming work orders, and/or the like. In addition, the work nodes 260A-260N may hold work items for outgoing like those described above.

In one embodiment, the work nodes 260A-260N may comprise a single work node 260 for holding work items. For example, the single work node 260 may have multiple contact center queues.

In FIG. 2, the router 250, the work nodes 260A-260N, the resource mapper 120, the resource nodes 130A-130N, and the resource selector 140 may be executing on separate servers on the network 110, executing as separate computer threads, executing on separate computer cores, and/or the like.

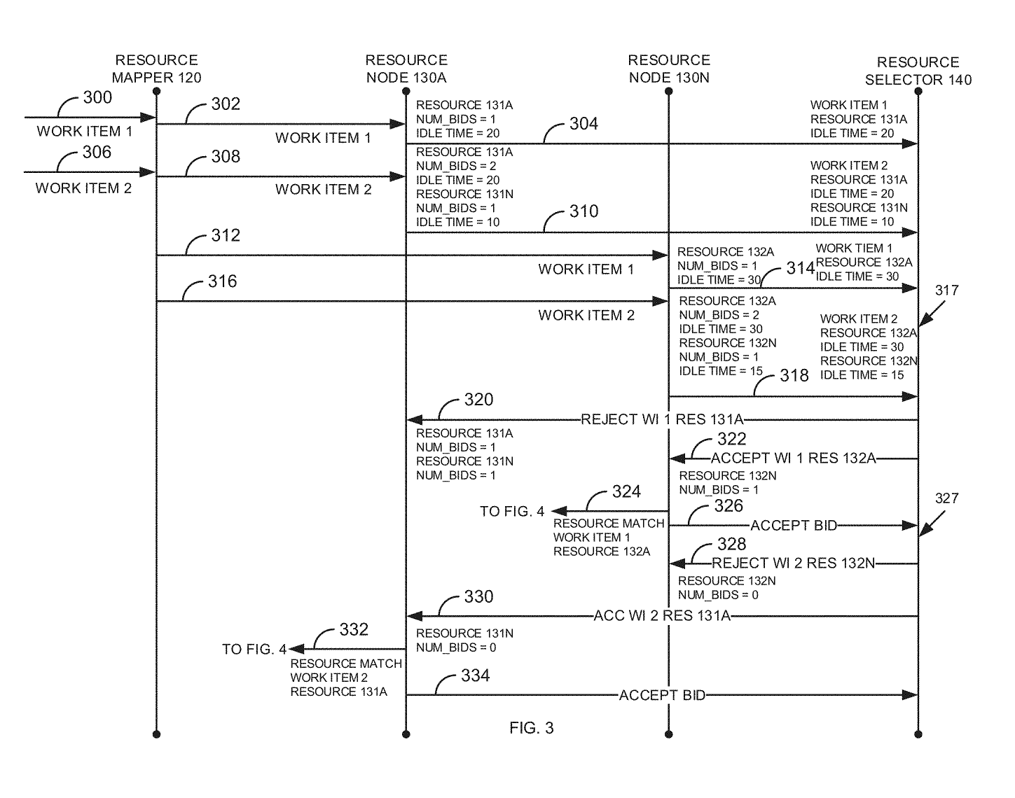

FIG. 3 is a flow diagram of a process for distribution of work items in a distributed work assignment system. Illustratively, communication endpoints 101A-101N, the resource mapper 120, the resource nodes 130A-130N, the resources 131A-131N (where they are devices), the resources 132A-132N (where they are devices), the resource selector 140, the router 250, and the work nodes 260A-260N, are stored-program-controlled entities, such as a computer or microprocessor, which performs the method of FIGS. 3-5 and the processes described herein by executing program instructions stored in a computer readable storage medium, such as a memory or disk. Although the methods described in FIGS. 3-5 are shown in a specific order, one of skill in the art would recognize that the steps in FIGS. 3-5 may be implemented in different orders and/or be implemented in a multi-threaded environment. Moreover, various steps may be omitted or added based on implementation.

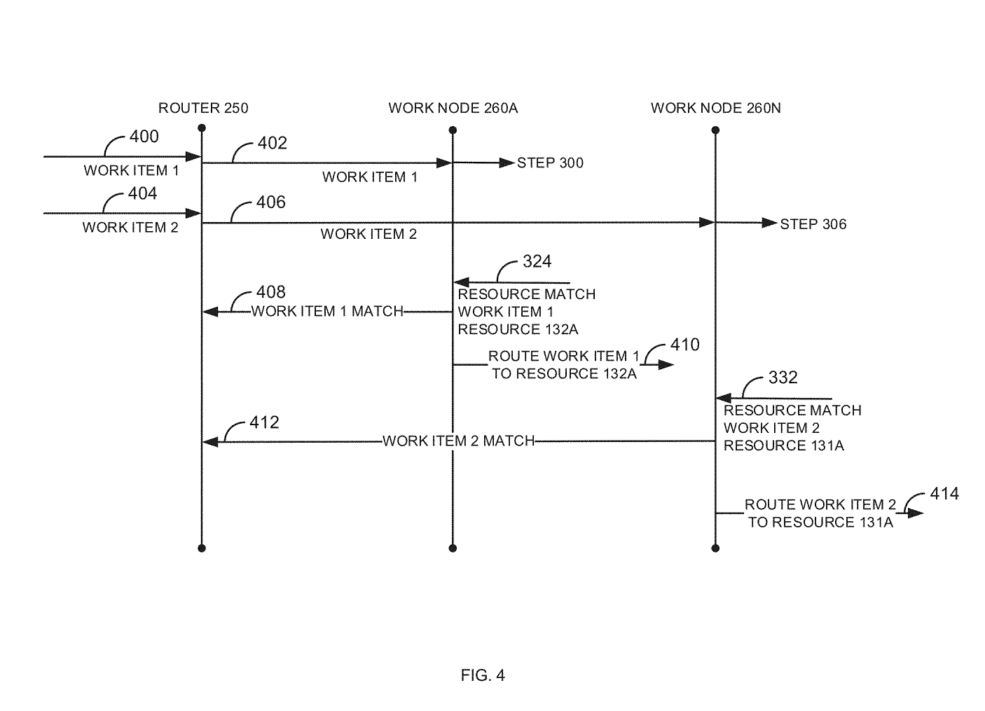

FIG. 3 is based on the embodiment described in FIG. 1. In FIG. 3, the work item 1 is received by the resource mapper 120 in step 300. The work item 1 may be directly sent to the resource mapper 120 (e.g., from a communication endpoint 101) or may be sent from a work node 260 as discussed in FIG. 4. The work item 1 may be an incoming work item or an outgoing work item. For example, the work item 1 may be an incoming call from a communication endpoint 101. Alternatively, the work item 1 may be an outgoing voice call made by an auto-dialer to be matched to a resource (e.g., a contact center agent). In FIG. 3, the resource mapper 120 sends a request to match the work items to each of the resource nodes 130A-130N. The resource nodes 130A-130N may comprise two or more resource nodes 130A-130N. The resource mapper 120 sends a request to match a resource 131A-131N to the work item 1, to the resource node 130A, in step 302.

The resource node 130A manages resources 131A-131N. In this example, the resources 131A-131N are contact center agents. For illustrative purposes, the resources 131A-131N comprises two agents. However, in other embodiments, the resources 131A-131N may comprises hundreds or even thousands of resources 131. The agent (resource 131A) has been idle for 20 seconds and the agent (resource 131N) has been idle for 10 seconds. The resource node 130A uses an algorithm that selects the agent (resource 131A-131N) that has been idle for the longest period of time. In this example, the resource node 130A selects the resource 131A because the agent has been idle longer (20 seconds) than the agent of resource 131N (10 seconds). The resource node 130A sends a bid, to the resource selector 140, for the work item 1 and for the resource 131A, that indicates that the resource 131A has an idle time of 20 seconds in step 304.

The resource node 130A also keeps track of a parameter called num_bids that indicates the number of outstanding bids for a resource 131. Since this is the first outstanding bid for the resource 131A, the resource node 130A sets the num_bids value=1 for the resource 131A.

At nearly the same time (i.e., concurrently) as receiving the work item 1 in step 300, the resource mapper 120 receives work item 2 in step 306. The resource mapper 120 also sends a request, to the resource node 130A, to match the work item 2 to a resource 131 in step 308. The resource node 130A determines that the best resource 131A-131N for the work item 2 is still the resource 131A because the resource 131A still has a higher idle time (20 seconds). However, the resource 131A already has a previous bid that may be accepted (the num_bids=1 for resource 131A). In this case, the resource node 130A still submits a bid on behalf of the resource 131A (based on the assumption that the first bid for the resource 131A may not be accepted). In addition, the resource node 130A also submits a bid for the resource 131N that has an idle time of 10 seconds (in case the bid for the resource 131A is accepted on the first bid). The resource node 130A sends the bid, in step 310, for the two resources 131A and 131N to the resource selector 140.

The resource node 130A also increments the num_bids for each of the resources 131A and 131N. Thus, the num_bids=2 for the resource 131A and the num_bids=1 for the resource 131N.

The resource mapper 120 also sends a request to match the work item 1 to resource node 130N in step 312. In this example, the resource mapper 120 sends the work item 1 to each of the resource nodes 130A-130N (two resource nodes 130 in this example). The resource node 130N determines that the resource 132A has the highest idle time (30 seconds). The resource node 130N sends a bid to the resource selector 140 that indicates that the resource 132A has an idle time of 30 seconds in step 314. The resource node 130N sets the num_bids=1 for the resource 132A.

The resource mapper 120 also sends a request to match the work item 2 to the resource node 130N in step 316. The resource node 130N determines that the resource 132A is still the best available resource 132. However, the resource 132A already has a previous bid that may be accepted (the num_bids=1 for resource 132A). In this case, the resource node 130N still submits a bid for the resource 132A (based on the assumption that the first bid for the resource 132A may not be accepted). In addition, the resource node 130N also submits a bid for the resource 132N that has an idle time of 15 seconds (in case the bid for the resource 132A is accepted on the first bid). The resource node 130N sends the bid, in step 318, for the two resources 132A and 132N to the resource selector 140.

The resource selector 140 determines, in step 317, a best available resource 131/132 from each of the bids received for work item 1 in steps 304 and 314. The resource selector 140 has received a bid for resource 131A (via resource node 130A) that has an idle time of 20 seconds and a bid for resource 132A (via resource node 130N) that has an idle time of 30 seconds. In this example, the resource selector 140 uses an algorithm that takes the resource 131/132 with the highest idle time (the bid from resource 132A with an idle time of 30 seconds).

The resource selector 140 sends a reject work item message, in step 320, to the resource node 130A to reject the bid for the resource 131A sent in step 304. In response to receiving the reject resource message for the work item 1 in step 320, the resource node 130A decrements the num_bids parameter for the work item 131A to 1 because there is only 1 outstanding bid for the work item 131A. The resource node 130A leaves the num_bids=1 for the resource 131N because this bid is still outstanding.

The resource selector 140 sends an accept work item message to the resource node 130N to accept the resource 132A for the work item 1 in step 322. In response to receiving the accept resource message for the work item 1 in step 322, the resource node 130N may send a message that causes the work item (e.g., a call) to be routed to the resource 132A (e.g., an agent communication device) in step 324. In a different embodiment, the resource node 130N sends the message of step 324 to work node 260A as discussed in FIG. 4. The resource node 130N sends, in step 326, an accept bid message to the resource selector 140. The messages of steps 320/322 and 324/326 may occur in reverse order.

When the resource node 130N receives the accept message of work item 1 to use resource 132A, in step 322, the resource node 130N excludes the resource 132A from additional bids until the resource 132A becomes free (e.g., the agent completes a voice call or responds to an email).

The resource selector 140 determines, in step 327, a best available resource 131/132 from each of the bids received for work item 2 in steps 310 and 318. The resource selector 140 has received a bid from resource 131A (via resource node 130A) that has an idle time of 20 seconds, a bid from resource 131N (via resource node 130A) that has an idle time of 10 seconds, a bid from resource 132A (via resource node 130N) that has an idle time of 30 seconds, and a bid from resource 132N (via resource node 130N) that has an idle time of 15 seconds. In this example, the resource selector 140 has already selected the resource 132A for the work item 1, so the resource selector 140 selects from the remaining resources (131A (20 seconds), 131N (10 seconds), and 132N (15 seconds)) a resource that has the highest idle time. In this case, the resource 131A has the highest idle time of 20 seconds.

The resource selector 140 sends, in step 328, to the resource node 130N a reject message for the bid for work item 2 sent in step 318 for the resource 132N. The resource node 130N decrements the num_bids parameter to 0 for the resource 132N.

The resource selector 140 sends, to the resource node 130A, an accept message for the work item 2 using the resource 131A, in step 330. Since the resource 131A was selected, the resource node 130A decrements the num_bids parameter=0 for the resource 131N. In response to receiving the accept work item message for the work item 2 in step 330, the resource node 130A sends a message, in step 332, to a device for routing the work item 2 to the resource 131A. In a different embodiment, the resource node 130A sends the message of step 332 to work node 260N as discussed in FIG. 4. The resource node 130A sends, in step 334, an accept bid message to the resource selector 140. The messages of steps 328/330 and 332/334 may occur in reverse order.

When the resource node 130A receives the accept message of work item 2 to use resource 131A, in step 330, the resource node 130A excludes the resource 131A from additional bids until the resource 131A becomes free (e.g., the agent completes a voice call or responds to an email).

In one embodiment, the work items may be a different type of work items that use a different algorithm for determining an available resource 131/132. For example, instead of contact center agents, the resources 131/132 may be airline seats and the algorithm is to find an airline seat with the lowest cost within a time period. In other embodiments, multiple parameters, such as a date, an idle time, seat, a shipping time, a cost, and/or the like may be used in the algorithm.

In one embodiment, the work items of different types may be intermixed. For example, voice work items (voice calls) may be intermixed with text work items (e.g., emails). The voice work items are managed using the algorithm discussed in FIG. 3 while the text messages are sent to an agent queue based on a number of outstanding emails the agent has not completed using a second algorithm. The resources 131/132 (agents) may be the same or different resources 131/132 that process the work items.

When the work items are received by the resource mapper 120 in steps 300 and 306, the resource mapper 120 determines the type of work item and its associated algorithm. When the resource mapper 120 sends the messages of step 302, 308, 312, and 316, the messages may also include the work item type or an algorithm to use for the type of work item (e.g., the algorithm is part of a method in an object oriented programming class).

FIG. 4 is a flow diagram of a process for distribution of work items in a distributed work assignment system. FIG. 4 is based on the embodiment described in FIGS. 2 and 3. In a second embodiment, the process of FIG. 3 may also include the router 250 and work nodes 260A-260N. For simplicity, only two work nodes 260A-260N will be discussed. However, any number of work nodes may be used from one to N where N is a positive integer.

The work item 1 is received by the router 250 in step 400. The router 250 routes the work items (e.g., incoming or outgoing calls) to the work nodes 260A-260N. For example, the router 250 may route work items to the work nodes 260A-260N using a round robin scheme where the first work item is routed to the work node 260A, the second work item is routed to the work node 260N, and repeated in like fashion for additional work items. The router 250 routes the work item 1 to the work node 260A in step 402. The work node 260A may hold the work item 1 for a period of time. For example, until a resource 131/132 is available for matching. The work node 260A can hold the work item 1 in a pool or a queue. The work node 260A may hold the work item 1 until receiving a match work item message (e.g., a message similar to the message of step 324). Once the work item is ready for the bidding process, the work node 260A send the work item 1 to the resource mapper 120 in step 300 of FIG. 3.

Similarly, the work item 2 is received at the router 250 in step 404. The router 250 routes the work item 2 to the work node 260N in step 406. When the work item 2 is ready for the bidding process, the work node 260N sends the work item 2 to the resource mapper 120 in step 306. For example, the work node 260N may hold a work item 2 until receiving a match work item message (e.g., a message similar to the message of step 332).

Once the work item 1 has been matched to the resource 132A, the message of step 324 is received by the work node 260A indicating that the work item 1 has been matched to the resource 132A. The work node 260A sends a work item 1 match message to the router 250 in step 408. The message of step 408 may also be used by the router 250 to determine which work node 260A-260N to send future work items to. The work node 260A then routes the work item 1 (e.g., that has been held in a queue) to the resource 132A (e.g., a telephone of agent 132A). In an alternative embodiment, instead of the work node 260A routing the work item 1, the router 250 may route the work item 1 instead.

Once the work item 2 has been matched to the resource 131A, the message of step 332 is received by the work node 260N indicating that the work item 2 has been matched to the resource 131A. The work node 260N sends a work item 2 match message to the router 250 in step 412. The message of step 412 may also be used by the router 250 to determine which work node 260A-260N to send future work items to. The work node 260N then routes the work item 2 to the resource 131A in step 414. In an alternative embodiment, instead of the work node 260A routing the work item 2, the router 250 may route the work item 2 instead.

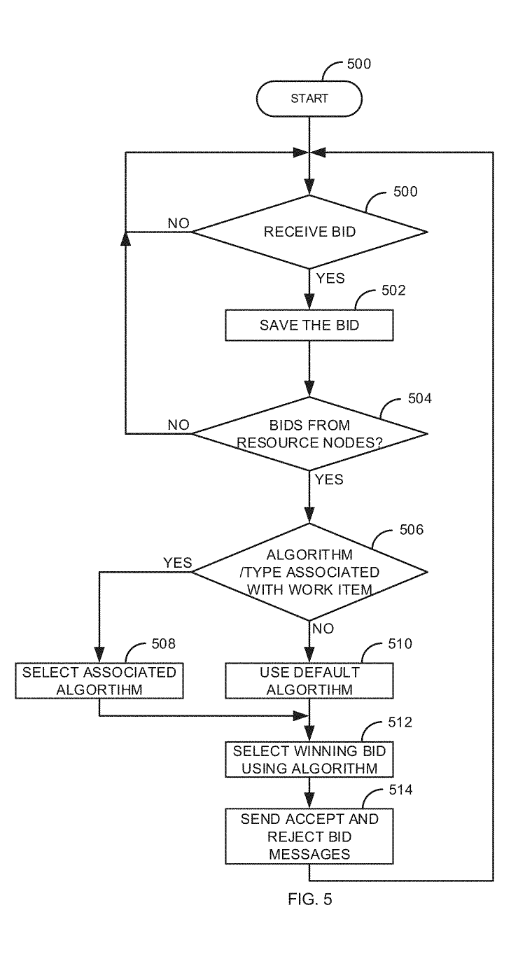

FIG. 5 is a flow diagram of a process for selecting a resource 131/132 to service a work item in a work assignment system. The method of FIG. 5 is used by the resource selector 140 for determining which resource 131/132 is the best match for a work item. The process of FIG. 5 may be implemented as a separate thread for each bid for a particular work item with the exception of step 512, which is typically serialized. However, step 512 may be implemented in a separate thread, for example, by using spin locks or semaphores.

The process starts in step 500. The resource selector 140 waits, in step 500, to receive a bid (e.g. the bid sent in step 304). If a bid has not been received in step 500, the process goes back to step 500 to wait to receive a bid. In step 500, a bid may indicate that the resource node 130 has no available resources 131/132. Once a bid is received, the resource selector 140 saves the bid in step 502. The resource selector 140 determines, in step 504, if a bid has been received from all the resource nodes 130A-130N that received a request to match a work item. For example, the resource mapper 120 may send a request to match a first type of work item to a defined number of resource nodes (e.g., 130A-130C) and second request to match a second type of work item to a different defined number of resource nodes (130C-130N) based on the type of resources 131/132 that each resource node 130 supports (e.g., agent capabilities).

If all the bids have not been received by the resource selector 140 in step 504, the process goes back to step 500 to wait to receive all the necessary bids. The process of steps 500-504 may also include a time-out period where if a bid is not received in the given time period (e.g., where a bid is lost or a resource node 130 fails), the process proceeds with receiving all the bids

Otherwise, if all bids have been received in step 504, the resource selector 140 determines, in step 506, if there is an algorithm or work item type associated with a bid. As discussed above, different types of work items may use different algorithms for selecting resources 131/132. If there is no algorithm/type associated with the work item in step 506 (e.g., only a single algorithm or work item type) the process goes to step 510 and uses the default algorithm for selecting the resource 131/132. Otherwise, if there is an algorithm type or work item type in step 506, the resource selector 140 selects the associated algorithm in step 508. The resource selector 140 then selects the winning bid using the algorithm in step 512. The resource selector 140 then sends accept/reject bid messages in step 514. The process then goes back to step 500.

The process of steps 506-512 is also used by the resources nodes 130A-130N.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJS™ processors, other industry-equivalent processors, and may perform computational functions using any known or future-developed standard, instruction set, libraries, and/or architecture.

Any of the steps, functions, and operations discussed herein can be performed continuously and automatically.

To avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that cause the microprocessor to execute:
a first resource node that receives a request to match a first work item from a resource mapper, wherein the first resource node manages a first one or more separate resources, determines a first best available resource among the first one or more separate resources, sends a first bid for the determined first best available resource to a resource selector, and receives a first accept or a first reject message for the sent first bid, wherein the request to match the first work item is also received at a second resource node that:
manages a second one or more separate resources, determines a second best available resource among the second one or more separate resources, sends a second bid for the determined second resource to the resource selector, and receives a second accept or a second reject message for the sent second bid.

2. The system of claim 1, wherein the first resource node receives a second work item from the resource mapper, wherein the first one or more separate resources comprises a first plurality of separate resources, determines a third best available resource among the first plurality of separate resources, sends a third bid for the determined third best available resource to the resource selector, and receives a third accept or a third reject message for the sent third bid.

3. The system of claim 2, wherein the first best available resource is the same resource as the third best available resource.

4. The system of claim 2, wherein the first work item and the second work item are different types of work items, wherein the first work item comprises a first indicator that identifies a first algorithm or a type of work item to determine the first and second best available resources, and wherein the second work item comprises a second indicator that identifies a second algorithm or a second type of work item to determine the third best available resource.

5. The system of claim 2, wherein the sent third bid comprises a plurality of bids for the first plurality of separate resources.

6. The system of claim 1, wherein the sent first bid comprises a first idle time of the first best available resource, wherein the sent second bid comprises a second idle time for the second best available resource, and wherein the resource selector selects the first best available resource based on the first idle time being higher than the second idle time.

7. The system of claim 1, wherein the first accept or the first reject message is the first accept message and wherein the first resource node excludes the first best available resource so that the first best available resource cannot be used in an additional bid until the first work item has been completed by the first best available resource.

8. The system of claim 1, wherein the resource mapper, the first and second resource nodes, and the resource selector are one or more of executed on a separate server, a separate computer thread, or a separate computer core.

9. The system of claim 1, wherein the first resource node manages a plurality of separate resources and determines a best available resource based on one or more parameters of the best available resource.

10. A method comprising:
receiving, by a microprocessor, a request to match a first work item from a resource mapper, wherein the microprocessor manages a first one or more separate resources, determines a first best available resource among the first one or more separate resources,
sending, by the microprocessor, a first bid for the determined first best available resource to a resource selector; and
receiving, by the microprocessor, a first accept or a first reject message for the sent first bid, wherein the request to match the first work item is also received at a resource node that: manages a second one or more separate resources, determines a second best available resource among the second one or more separate resources, sends a second bid for the determined second best available resource to the resource selector, and receives a second accept or a second reject message for the sent second bid.

11. The method of claim 10, wherein the first one or more separate resources comprises a first plurality of separate resources and further comprising:
receiving, by the microprocessor, a second work item from the resource mapper;
determining, by the microprocessor, a third best available resource among the first plurality of separate resources;
sending, by the microprocessor, a third bid for the determined third best available resource to the resource selector; and
receiving, by the microprocessor, a third accept or a third reject message for the sent third bid.

12. The method of claim 11, wherein the first best available resource is the same resource as the third best available resource.

13. The method of claim 11, wherein the first work item and the second work item are different types of work items, wherein the first work item comprises a first indicator that identifies a first algorithm or first type of work item to determine the first and second best available resources, and wherein the second work item comprises a second indicator that identifies a second algorithm or a second type of work item to determine the third best available resource.

14. The method of claim 11, wherein the sent third bid comprises a plurality of bids for the first plurality of separate resources.

15. The method of claim 10, wherein the sent first bid comprises a first idle time of the first best available resource, wherein the sent second bid comprises a second idle time for the second best available resource, and wherein the resource selector selects the first best available resource based on the first idle time being higher than the second idle time.

16. The method of claim 10, wherein the first accept or the first reject message is the first accept message and wherein the microprocessor excludes the first best available resource so that the first best available resource cannot be used in an additional bid until the first work item has been completed by the first best available resource.

17. The method of claim 10, wherein the resource mapper, the resource node, and the resource selector are one or more of executed on a separate server, a separate computer thread, or a separate computer core.

18. The method of claim 10, wherein the microprocessor manages a plurality of separate resources and determines a best available resource based on one or more parameters of the best available resource.

19. A system comprising:
a microprocessor; and
a computer readable medium, coupled with the microprocessor and comprising microprocessor readable and executable instructions that cause the microprocessor to execute:
a resource mapper that receives a work item, maps the work item to a plurality of resource nodes, and sends the work item to the plurality of resource nodes; and
the plurality of resource nodes, wherein each of the plurality of resource nodes respectively:
manages one or more separate resources;
receives the work item from a resource mapper;
determines a best available resource among the respective one or more separate resources;
sends a bid for the determined best available resource to a resource selector; and
receives an accept or a reject message for the sent bid to the resource selector; and
the resource selector that receives the respective plurality of bids from the plurality of resource nodes, determines an overall best available resource from the respective plurality of bids from the plurality of resource nodes, and sends the respective plurality of accept or reject messages to the plurality of resource nodes.

20. The system of claim above, further comprising:
a router that routes the work item to one of a plurality of work nodes, wherein the one of the plurality of work nodes holds the work item until receiving a notification from the resource mapper that a resource is available to service the work item and sends the work item to the resource mapper in response to receiving the notification from the resource mapper.
